(19) United States
(12) Patent Application Publication
(10) Pub. No.: US 2026/0301578 A1
(43) Pub. Date: Oct. 1, 2026

(54) VEHICLE CONTROL DEVICE, VEHICLE CONTROL METHOD AND STORAGE MEDIUM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Masahide KUWATA, Tokyo (JP); Yuji KOSAKA, Tokyo (JP); Takahiro NAKANO, Tokyo (JP)

(21) Appl. No.: 19/575,148

(22) Filed: Mar. 23, 2026

(30) Foreign Application Priority Data
Mar. 25, 2025 (JP) 2025-050652

(51) Int. Cl. G08G 1/16; B60W 30/09; B60W 50/14; G06V 20/58; G08G 1/0967

(52) U.S. Cl. CPC G08G 1/167; B60W 30/09; B60W 50/14; G06V 20/58; G08G 1/096766; B60W 2050/146; B60W 2420/403; B60W 2520/10; B60W 2552/10; B60W 2554/4045; G06V 2201/08

(57) ABSTRACT

An ECU includes a close-range determination unit determining whether a close-range state occurs in which a separation distance to the other vehicle cutting in front of the host vehicle is smaller than a close-range determination value, a cut-off determination unit determining whether a cut-off state occurs in which the other vehicle is detected in an image captured by a camera and a rear end of the other vehicle is cut off in the captured image, a first deceleration control unit controlling a deceleration of the host vehicle based on the separation distance in response to a determination that the close-range state occurs and a determination that the cut-off state does not occur, and a second deceleration control unit controlling the deceleration of the host vehicle to a predetermined deceleration irrespective of the separation distance in response to a determination that the cut-off state occurs.

### CROSS-REFERENCE TO RELATED APPLICATION

This application is based on and claims the benefit of priority from earlier Japanese Patent Application No. 2025-050652 filed Mar. 25, 2025, the description of which is incorporated herein by reference.

### BACKGROUND

### TECHNICAL FIELD

The present disclosure relates to a vehicle control device, vehicle control method and storage medium.

### BACKGROUND ART

In vehicle control devices that assist traveling of a host vehicle, there has been known a technology in which another vehicle cutting in front of the host vehicle from an adjacent lane is detected and the acceleration/deceleration of the host vehicle is controlled in accordance with the cut-in of the other vehicle.

### SUMMARY

In the present disclosure, provided is a vehicle control device as follows.

The vehicle control device performs a deceleration control to decelerate a host vehicle in a case where another vehicle traveling on an adjacent lane cuts in front of the host vehicle traveling on a host lane. The vehicle control device includes at least one of (i) a circuit and (ii) a processor with a memory storing computer program code executable by the processor, the at least one of the circuit and the processor configured to cause the vehicle control device to: determine whether a close-range state occurs in which a separation distance to the other vehicle cutting in front of the host vehicle is smaller than a predetermined close-range determination value; determine, in response to determining that the close-range state occurs, whether a cut-off state occurs in which the other vehicle is detected in a captured image and a rear end of the other vehicle is cut off in the captured image; control, in response to determining that the close-range state occurs and determining that the cut-off state does not occur, a deceleration of the host vehicle for the deceleration control based on the separation distance; and control, in response to determining that the cut-off state occurs, the deceleration of the host vehicle for the deceleration control to a predetermined deceleration irrespective of the separation distance.

### BRIEF DESCRIPTION OF THE DRAWINGS

FIG. 1 is a configuration diagram illustrating an overview of a driving assistance system for a vehicle according to a first embodiment.

FIG. 2 is a diagram illustrating an object detection range of a camera on a vehicle front side. FIG. 3 is a diagram illustrating an example of a scene of cut-in of another vehicle.

FIG. 4 is a diagram illustrating an example of a camera image of a scene of close-range cut-in of another vehicle.

FIG. 5 is a diagram illustrating an example of a scene of close-range cut-in scene of another vehicle.

FIG. 6 is a flowchart illustrating a processing procedure of a control performed by an ECU.

FIG. 7 is a timing chart illustrating a control example of a deceleration control.

FIG. 8 is a flowchart illustrating a processing procedure of a warning control.

FIGS. 9A-9C are a joint diagram illustrating an example of an execution mode of warning.

FIG. 10 is a diagram illustrating a method of setting a predetermined deceleration according to a modification example of the first embodiment.

FIG. 11 is a diagram illustrating a method of setting a target deceleration according to a second embodiment.

FIG. 12 is a diagram illustrating the method of setting the target deceleration.

FIG. 13 is a timing chart illustrating a control example of a deceleration control.

### DETAILED DESCRIPTION OF THE PREFERRED EMBODIMENTS

[PTL 1] International Publication No. WO 2022/269980

In a case where another vehicle is cutting in front of the host vehicle, it is assumed that a cut-in position of the other vehicle is relatively close to the host vehicle. In this case, the cut-in vehicle is at a close range relative to the host vehicle, which raises a concern that for example, a part of the cut-in vehicle may be out of an imaging region of an image sensor, resulting in a failure in an appropriate deceleration control of the host vehicle.

For example, in the technology according to PTL 1, in a situation in which a back side of a cut-in vehicle is out of the imaging region of the image sensor, a rear end position of the cut-in vehicle is predicted based on side surface information regarding a captured image of the cut-in vehicle. However, if a prediction accuracy of the rear end position based on the side surface information regarding the cut-in vehicle is low, there is a concern that a deceleration during the deceleration control becomes excessive or insufficient as the deceleration control is performed based on the predicted rear end position.

The present disclosure is provided in view of the above circumstances and a main purpose thereof is to provide a vehicle control device, vehicle control method and storage medium capable of performing an appropriate deceleration control even though another vehicle is cutting in front of a host vehicle at a position close to the host vehicle.

A vehicle control device (10) applicable to a vehicle, the vehicle including, as a detection device that detects an object around a host vehicle, an image sensor (21) configured to capture an image of surroundings of the host vehicle to acquire a captured image,
the vehicle control device performing a deceleration control to decelerate the host vehicle based on detection information regarding another vehicle provided by the detection device in response to the other vehicle traveling on an adjacent lane cutting in front of a host vehicle traveling on a host lane, the adjacent lane being adjacent to the host lane and being same in vehicle traveling direction as the host lane,
the vehicle control device comprising:
a close-range determination unit (12) configured to determine whether a close-range state occurs in which a separation distance to the other vehicle cutting in front of the host vehicle is smaller than a predetermined close-range determination value;
a cut-off determination unit (13) configured to determine, in response to the close-range determination unit determining that the close-range state occurs, whether a cut-off state occurs in which the other vehicle is detected in the captured image and a rear end of the other vehicle is cut off in the captured image;
a first deceleration control unit (14) configured to control, in response to the close-range determination unit determining that the close-range state occurs and the cut-off determination unit determining that the cut-off state does not occur, a deceleration of the host vehicle for the deceleration control based on the separation distance;
and a second deceleration control unit (15) configured to control, in response to the cut-off determination unit determining that the cut-off state occurs, the deceleration of the host vehicle for the deceleration control to a predetermined deceleration irrespective of the separation distance.

According to the present disclosure, in a case where another vehicle traveling on an adjacent lane is cutting in front of a host vehicle traveling on a host lane, it is determined whether a close-range state occurs in which a separation distance to the other vehicle cutting in front of the host vehicle is smaller than a predetermined close-range determination value. In a case where it is determined that the close-range state occurs, a rear end of the other vehicle may be cut off in a captured image and a detection accuracy of the separation distance may decrease. In this case, there is a concern that a deceleration control based on the separation distance may fail to be appropriately performed.

Accordingly, in response to the determination that the close-range state occurs, it is determined whether a cut-off state of the other vehicle occurs. In response to the determination that the cut-off state does not occur, a deceleration of the host vehicle for the deceleration control is controlled based on the separation distance. In response to the determination that the cut-off state occurs, the deceleration of the host vehicle for the deceleration control is controlled to be a predetermined deceleration irrespective of the separation distance. This makes it possible to decelerate the host vehicle while suppressing an adverse influence of the cut-off state on the deceleration control as compared with in a comparative example in which the execution mode of the deceleration control is not changed in accordance with whether the cut-off state occurs. For example, as compared with in a comparative example in which the deceleration of the host vehicle is controlled based on the separation distance irrespective of whether the cut-off state occurs, it is possible to prevent the deceleration for the deceleration control from being unintentionally controlled to be low due to a decrease in the detection accuracy of the separation distance and, consequently, suppress occurrence of insufficient deceleration of the host vehicle. Therefore, it is possible to perform an appropriate deceleration control even though the other vehicle is cutting in front of the host vehicle at a position close to the host vehicle.

### First Embodiment

Description will be given below on an embodiment exemplifying a vehicle control device according to the present disclosure with reference to the drawings. In the present embodiment, for example, a driving assistance system may be configured to perform vehicle driving assistance for a vehicle such as a passenger car, a truck, or a bus.

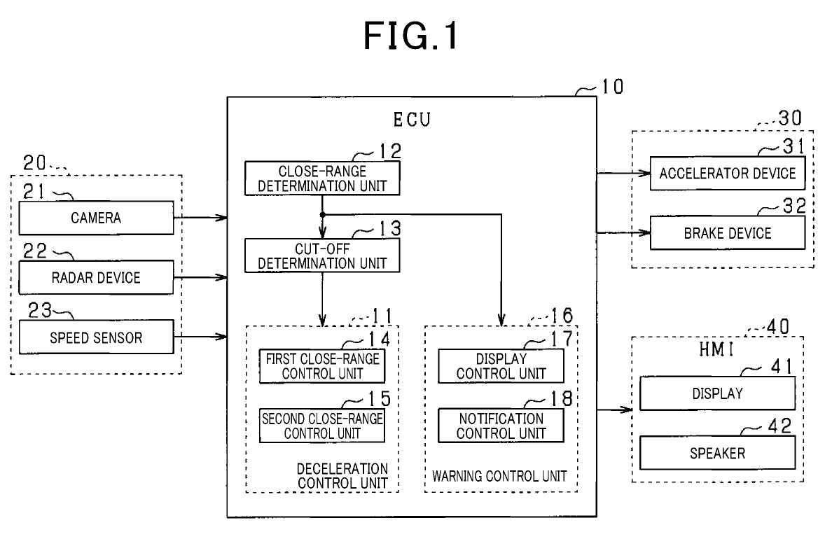

As illustrated in FIG. 1, a driving assistance system according to the present embodiment includes an Electronic Control Unit (ECU) 10, which is a vehicle control device, sensors 20, a controlled device 30, and a Human Machine Interface 40 (HMI). The sensors 20 include a camera 21, which is an image sensor, a radar device 22, and a speed sensor 23. The camera 21 and the radar device 22 correspond to a "detection device." The controlled device 30 includes an accelerator device 31 and a brake device 32. The HMI 40 includes a display 41 and a speaker 42. The display 41 is provided at a position visible by a driver in a driver's seat of the vehicle. In the present embodiment, the HMI 40 corresponds to a "warning device" and the display 41 corresponds to a "display unit."

The camera 21 may be, for example, a monocular camera. The camera 21 includes, for example, a plurality of imaging devices capable of capturing respective images on front, rear, and both of right and left sides of a host vehicle. Images of the surrounding of the host vehicle are captured by these cameras 21. The cameral 21 that captures an image on the front side of the vehicle is provided above a windshield of the vehicle or near a front bumper of the vehicle. The cameras 21 send captured images to the ECU 10 in a predetermined cycle. It should be noted that the camera 21 may be a stereo camera.

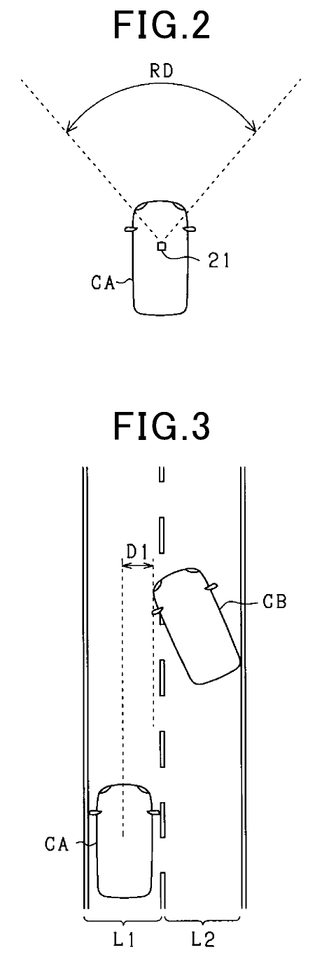

FIG. 2 illustrates an object detection range of the camera 21 on the vehicle-front side. In FIG. 2, one of the cameras 21 is provided at a middle position above the windshield of the vehicle, so that the camera 21 on the front side of the host vehicle is able to detect an object that is present within an imaging region RD on the front side of the host vehicle.

The radar device 22 is a ranging device that uses a high-frequency signal in a millimeter-wave band as a transmission wave. The radar device 22, which is mounted at, for example, each of a front end, a rear end, and both of right and left side surfaces, measures a distance to an object around the host vehicle. Specifically, the radar device 22 transmits a probing wave in a predetermined cycle and receives reflected waves via a plurality of antennas, measuring a distance to an object in accordance with a time point of transmission of the probing wave and a time point of reception of the reflected wave. The radar device 22 also calculates an azimuth of the object in accordance with a phase difference among reflected waves received by the plurality of antennas. It is possible to identify a relative position of the object relative to the host vehicle by calculating the distance to the object and the azimuth of the object.

The speed sensor 23 is a sensor that detects a traveling speed of the host vehicle. For example, the speed sensor 23 may be a wheel speed sensor that detects a rotation speed of a wheel. A detection value of the speed sensor 23 is to be inputted to the ECU 10.

The ECU 10 is an electronic control device including a known microcomputer including a CPU, a ROM, a RAM, a flash memory, and the like. The microcomputer provides a variety of computational functions. The functions provided by the microcomputer may be provided by software recorded in a tangible memory device and a computer that executes the software, software only, hardware only, or a combination thereof. The microcomputer executes a program stored in, for example, a non-transitory tangible storage medium, which is a storage unit provided in the microcomputer. The program contains, for example, a program related to a driving assistance control of the host vehicle, such as an object recognition process to recognize an object around the host vehicle, a process to avoid a collision with an object around the host vehicle or reduce damage from a collision, and a process to control the traveling speed of the host vehicle. As the program is executed, a method corresponding to the program is performed. The storage unit is, for example, a non-volatile memory. It should be noted that the program stored in the storage unit may be updated via, for example, a network such as the Internet.

The vehicle control device is not limited to an electronic control device including a microcomputer, and may be configured by dedicated circuits, logic circuits, ASICs, FPGAs, or a combination thereof.

The ECU 10 acquires object detection information from each of the cameras 21 and the radar devices 22 and recognizes an object around the host vehicle based on the information. Specifically, the ECU 10 calculates, as image information, a relative position, a presence region, and the like of the object using the distance to the object and the azimuth of the object calculated from the camera images. The ECU 10 calculates, as radar information, a relative position, a presence region, and the like of the object using the distance to the object and the azimuth of the object contained in distance information acquired from the radar devices 22. The ECU 10 performs fusion of the image information and the radar information to recognize the object. At this time, the object is to be recognized based on an overlap of the presence region of the object contained in the image information and the presence region of the object contained in the radar information. Incidentally, a technique of object recognition is not limited in the present embodiment. For example, the object may be recognized based on, out of the object detection information from the cameras 21 and the object detection information from the radar devices 22, only the object detection information from the cameras 21 or only the object detection information from the radar devices 22.

ECU 10 performs, as the driving assistance control of the host vehicle, Adaptive Cruise Control (ACC) control. The ACC control is a control for causing the host vehicle to travel at a constant speed based on a target speed set by a driver and, in response to the presence of a preceding vehicle traveling ahead in a traveling direction of the host vehicle, causing the host vehicle to follow the preceding vehicle while maintaining a predetermined inter-vehicle distance to the preceding vehicle. While performing the ACC control, the ECU 10 searches for any preceding vehicle that is a following target ahead in the traveling direction of the host vehicle. As long as no preceding vehicle is present, the ECU 10 causes the host vehicle to travel at a constant speed, which is the target speed. As long as a preceding vehicle is present, the ECU 10 causes the host vehicle to travel while maintaining the inter-vehicle distance to the preceding vehicle at a target inter-vehicle distance. At this time, the ECU 10 adjusts a driving force and a braking force of the host vehicle using the controlled device 30 in order to perform a speed control of the host vehicle.

In the present embodiment, the vehicle is mounted with, as the controlled devices 30, the accelerator device 31 and the brake device 32. The accelerator device 31 is an engine or a motor serving as a vehicle power source. When the driver operates an accelerator, the driving force is applied to the host vehicle in accordance with a control command from the ECU 10. The brake device 32 is provided in each of wheels of the vehicle. When the driver operates a brake, the braking force is applied to the host vehicle in accordance with a control command from the ECU 10.

It should be noted that the ACC control may be turned on and off by the driver. For example, when the driver turns on a set switch, the ECU 10 performs the ACC control. When a predetermined cancel condition is satisfied, for example, when the driver turns off the set switch, the ACC control by the ECU 10 is stopped.

The ECU 10 includes a deceleration control unit 11. The deceleration control unit 11 performs a deceleration control as the driving assistance control of the host vehicle. The deceleration control is a control for decelerating the host vehicle in a cut-in scene in which while the host vehicle travels on a host lane, another vehicle traveling on an adjacent lane that is the same in vehicle traveling direction as the host lane is cutting in front of the host vehicle. During the deceleration control, the ECU 10 sets a target deceleration AD* of a host vehicle CA. The ECU 10 causes the accelerator device 31 and the brake device 32 to operate to apply the braking force to the host vehicle so that a deceleration of the host vehicle CA reaches the set target deceleration AD*.

FIG. 3 illustrates an example of a cut-in scene of another vehicle CB. In FIG. 3, on a road including a host lane L1 and an adjacent lane L2, the host vehicle CA travels on the host lane L1 and the other vehicle CB travels on the adjacent lane L2. In this scene, the other vehicle CB moves in a lateral direction perpendicular to the traveling direction of the host vehicle CA, cutting in front of the host vehicle CA on the host lane L1.

During the deceleration control, the ECU 10 determines whether the other vehicle CB is cutting in front of the host vehicle CA based on the object detection information acquired from at least one of the cameras 21 or the radar devices 22. The following three methods are employable as a method of determining whether the other vehicle CB is cutting in front of the host vehicle CA.
(A) In a first example, the ECU 10 recognizes lane markings (while lines) on the right and left of the host lane L1 and determines whether the other vehicle CB traveling on the adjacent lane L2 moves in the lateral direction to reach the lane marking between the host lane L1 and the adjacent lane L2. In response to determining that the other vehicle CB reaching the lane marking between the lanes L1 and L2 in the lateral direction, the ECU 10 determines that the other vehicle CB is cutting in front of the host vehicle CA.
   A lane marking on a road surface may be recognized based on a change in luminance on an image acquired from the camera 21. Specifically, the ECU 10 extracts a change point of contrast (edge intensity) on the road surface as an edge candidate point for a lane marking such as a white line defining lanes on the road surface. Then, the lane marking is extracted from a sequence of extracted edge candidate points.
   The other vehicle CB traveling on the adjacent lane L2 may be determined to move in the lateral direction to reach the lane marking between the lanes L1 and L2 based on an analysis result of a camera image. In this case, when a closest portion of the other vehicle CB to the host lane L1 (for example, a right front corner of the other vehicle CB or a front wheel position on a host-vehicle side of the other vehicle CB) as recognized from the camera image is determined to intersect the lane marking, it may be determined that a situation in which the other vehicle CB is cutting in front of the host vehicle CA occurs.
(B) In a second example, in response to a lateral distance D1 from the host vehicle CA to the other vehicle CB (see FIG. 3) reaching a predetermined cut-in determination value or less, the ECU 10 determines that the other vehicle CB is cutting in front of the host vehicle CA. The cut-in determination value may be, for example, a value defined, in a case where a lane marking of the host lane L1 is recognized, as a distance from a center position in a right-left direction to the lane marking.
(C) In a third example, the ECU 10 determines whether the other vehicle CB is cutting in front of the host vehicle CA based on not only the lateral distance D1 but also an inclination (a yaw-direction inclination) of the other vehicle CB relative to the traveling direction of the host vehicle CA. For example, the ECU 10 estimates the yaw-direction inclination of the other vehicle CB from an angle made by a side surface of the other vehicle CB and the lane marking on the image acquired from the camera 21. Alternatively, the ECU 10 may be configured to acquire yaw-direction inclination information regarding the other vehicle CB through a vehicle-to-vehicle communication between the host vehicle CA and the other vehicle CB or a road-to-vehicle communication between the host vehicle CA and a road-side device. For example, the ECU 10 determines, in response to the yaw-direction inclination of the other vehicle CB being ±20 deg or greater, that the other vehicle CB is cutting in front of the host vehicle CA.

In this regard, in a case where the other vehicle CB is cutting in front of the host vehicle, a cut-in position of the other vehicle CB may be a position relatively close to the host vehicle CA. For example, in a situation in which the host vehicle CA travels at a low speed, the other vehicle CB on the adjacent lane L2 may forcibly cut in at a position close to the host vehicle CA. In this case, the cut-in vehicle is at a close range relative to the host vehicle CA, which raises a concern that a detection accuracy of the cut-in vehicle decreases, resulting in a failure to appropriately perform the speed control of the host vehicle CA.

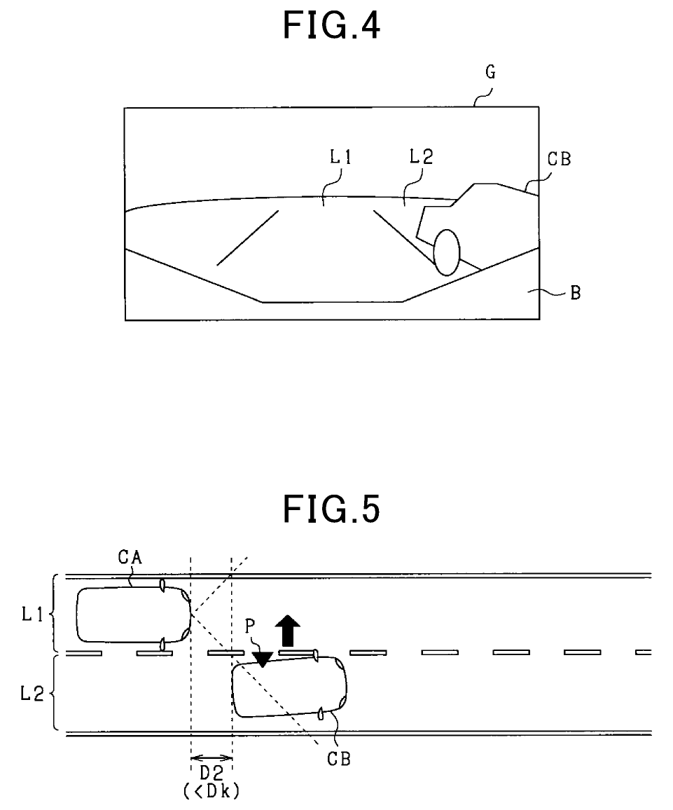

For example, in a close-range cut-in scene, a rear end of the other vehicle CB is out of the imaging region of the camera 21, so that the rear end of the other vehicle CB may be cut off in an image G captured by the camera 21 as illustrated in FIG. 4. In this case, there is a concern that accuracy of object recognition by pattern matching or the like decreases, resulting in a failure to correctly obtain a relative position and a relative speed of the other vehicle CB relative to the host vehicle CA and, consequently, a failure to appropriately perform the deceleration control of the host vehicle CA while the other vehicle CB is cutting in.

A part of the host vehicle CA may appear in the image G captured by the camera 21. Specifically, a vehicle body B (for example, a portion corresponding to an engine hood) of the host vehicle CA appears in the image G captured by the camera 21 on the vehicle front side in FIG. 4. In this case, there is a concern that the appearing portion of the vehicle body B and the other vehicle CB overlap in the image G captured by the camera 21, causing the rear end of the other vehicle CB to be cut off or increasing a cut-off region of the other vehicle CB.

It should be noted that in the close-range cut-in scene, a decrease in accuracy of object recognition using the radar device 22 is also of concern. For example, only a part of the other vehicle CB traveling on the adjacent lane L2 is within a detection range of the radar device 22 of the host vehicle CA and a side surface of the other vehicle CB serves as a target object detection portion P as illustrated in FIG. 5. In this case, the target object detection portion P is changeable anywhere in a vehicle longitudinal direction in the side surface of the other vehicle CB, which raises a concern that the relative position and the relative speed of the other vehicle CB relative to the host vehicle CA fail to be correctly obtained and, consequently, a control accuracy for the deceleration control of the host vehicle CA decreases.

In view of the above point, the ECU 10 includes, as a configuration for appropriately performing the deceleration control in the close-range cut-in scene, a close-range determination unit 12 and a cut-off determination unit 13 in the present embodiment.

In a case where the other vehicle CB is cutting in front of the host vehicle CA, the close-range determination unit 12 determines whether a close-range cut-in state (corresponding to a "close-range state") occurs. The close-range cut-in state is a state in which a separation distance (that is, a longitudinal distance D2) between the host vehicle CA and the other vehicle CB cutting in front of the host vehicle is smaller than a predetermined determination value. The close-range determination unit 12 may use, as the longitudinal distance D2, a value calculated based on the object detection information provided from at least one of the cameras 21 or the radar devices 22.

In the present embodiment, a close-range determination value Dk and a cancel determination value Dc are defined as the determination values for determining whether the close-range cut-in state occurs. The close-range determination value Dk is, for example, a value of less than 15 m, more specifically, 10 m. The cancel determination value Dc is a value greater than the close-range determination value Dk, for example, 15 m.

In a case where it is determined that the close-range cut-in state does not occur, the close-range determination unit 12 determines whether a start condition is satisfied. The start condition is that the longitudinal distance D2 is smaller than the close-range determination value Dk. In response to determining that the start condition is satisfied, the close-range determination unit 12 performs switching from a determination that the close-range cut-in state does not occur to a determination that the close-range cut-in state occurs. In response to determining that the start condition is not satisfied, the close-range determination unit 12 continues to determine that the close-range cut-in state does not occur.

In a case where determining that the close-range cut-in state occurs, the close-range determination unit 12 determines whether the cancel condition is satisfied. The cancel condition is that the longitudinal distance D2 is greater than the cancel determination value Dc. In response to determining that the cancel condition is not satisfied, the close-range determination unit 12 continues to determine that the close-range cut-in state occurs. In response to determining that the cancel condition is satisfied, the close-range determination unit 12 performs switching from the determination that the close-range cut-in state occurs to the determination that the close-range cut-in state does not occur. Using the determination values Dk and Dc to determine whether the close-range cut-in state occurs makes it possible to suppress the occurrence of hunting that is a repetition of the determination that the close-range cut-in state occurs and the determination that the close-range cut-in state does not occur.

In response to the close-range determination unit 12 determining that the close-range cut-in state occurs, the cut-off determination unit 13 determines whether the other vehicle CB detected in an image captured by the camera 21 is in a cut-off state. The cut-off state is a state in which the rear end of the other vehicle CB is cut off in the image captured by the camera 21. The cut-off state includes a case where the rear end of the other vehicle CB is out of the imaging region of the camera 21 and a case where an appearing portion of the vehicle body B and the rear end of the other vehicle CB overlap in the image captured by the camera 21. For example, the cut-off determination unit 13 may use a known pattern matching process to determine whether the rear end of the other vehicle CB is cut off.

The deceleration control unit 11 includes, as a configuration for changing an execution mode of the deceleration control in accordance with whether the cut-off state occurs in the close-range cut-in scene, a first close-range control unit 14 and a second close-range control unit 15. In response to the cut-off determination unit 13 determining that the cut-off state does not occur, a deceleration control (hereinafter, "first close-range control") is performed by the first close-range control unit 14. In response to the cut-off determination unit 13 determining that the cut-off state occurs, a deceleration control (hereinafter, "second close-range control") is performed by the second close-range control unit 15. In the present embodiment, the first close-range control unit 14 corresponds to a "first deceleration control unit" and the second close-range control unit 15 corresponds to a "second deceleration control unit."

In response to the close-range determination unit 12 determining that the close-range cut-in state occurs and the cut-off determination unit 13 determining that the cut-off state does not occur, the first close-range control unit 14 performs the first close-range control. During the first close-range control, the first close-range control unit 14 sets the target deceleration AD* based on the longitudinal distance D2.

For example, the target deceleration AD* is set as follows during the first close-range control. In a first example, in response to the longitudinal distance D2 exceeding a predetermined distance, the first close-range control unit 14 sets the target deceleration AD* to a value smaller than in a case where the longitudinal distance D2 is less than the predetermined distance. In a second example, the first close-range control unit 14 gradually reduces the target deceleration AD* with an increase in the longitudinal distance D2.

It should be noted that the deceleration of the host vehicle CA is set as a negative target acceleration rate in the present embodiment. In this case, an increase in the deceleration corresponds to a reduction in the negative acceleration, whereas a reduction in the deceleration corresponds to an increase in the acceleration within a negative range.

In response to the cut-off determination unit 13 determining that the cut-off state occurs, the second close-range control unit 15 performs the second close-range control. During the second close-range control, the second close-range control unit 15 sets the target deceleration AD* to a predetermined deceleration ADa irrespective of the longitudinal distance D2. The second close-range control is a control for performing an auxiliary deceleration before the other vehicle CB cutting in front of the host vehicle is recognized as a preceding vehicle and a main deceleration based on a following control is performed. Thus, the predetermined deceleration ADa is lower than a maximum value of the deceleration set for the following control relative to the preceding vehicle. For example, the maximum value of the deceleration set for the following control may be -0.5 G and the predetermined deceleration ADa may be -0.1 G.

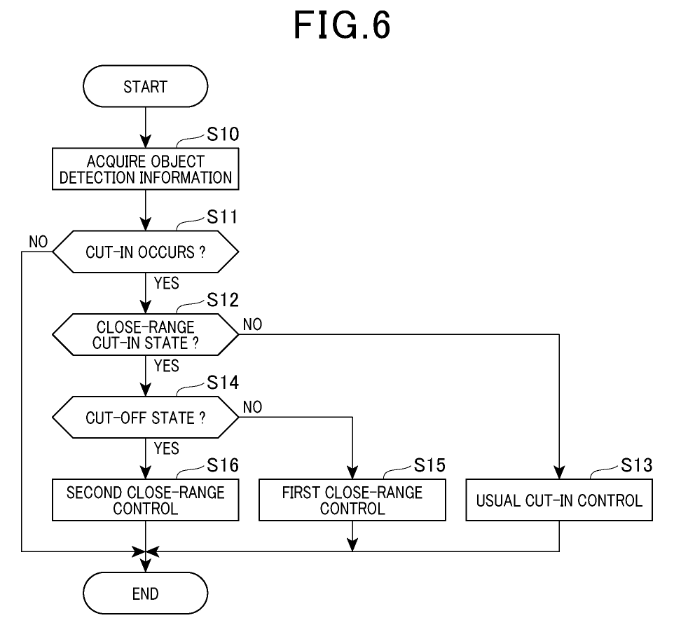

FIG. 6 illustrates a processing procedure of a control to be performed by the ECU 10. This control is to be repeatedly performed in a predetermined cycle.

In Step S10, the close-range determination unit 12 acquires the object detection information. The object detection information contains the lateral distance D1, the longitudinal distance D2, and an image captured by the camera 21. In Steps S11 and S12, the close-range determination unit 12 determines whether the cut-in of the other vehicle CB in front of the host vehicle corresponds to close-range cut-in. In detail, it is determined whether the other vehicle CB is cutting in front of the host vehicle CA based on the acquired lateral distance D1 in Step S11. In response to the negative determination in Step S11, this control is terminated. In response to the positive determination in Step S11, the process proceeds to Step S12. In Step S12, it is determined whether the close-range cut-in state occurs based on the acquired longitudinal distance D2. In the present embodiment, in a case where it is determined that the close-range cut-in state does not occur, it is determined whether the start condition is satisfied. In a case where it is determined that the close-range cut-in state occurs, it is determined whether the cancel condition is satisfied. In response to the start condition being determined to be satisfied or the cancel condition being determined to be not satisfied, the positive determination is made in Step S12. In response to the start condition being determined to be not satisfied or the cancel condition being determined to be satisfied, the negative determination is made in Step S12.

In response to the negative determination in Step S12, it is determined that the cut-in of the other vehicle CB in front of the host vehicle does not correspond to the close-range cut-in and the process proceeds to Step S13. In Step S13, the deceleration control unit 11 performs a usual cut-in control. The usual cut-in control is a control to recognize the other vehicle CB cutting in front of the host vehicle as a preceding vehicle and cause an inter-vehicle distance to the preceding vehicle to become the target inter-vehicle distance. In a case where the inter-vehicle distance to the preceding vehicle is less than the target inter-vehicle distance, the host vehicle CA is decelerated to increase the inter-vehicle distance. In a case where the cut-in of the other vehicle CB recognized as the preceding vehicle is completed, the following control of the host vehicle CA relative to the preceding vehicle is performed.

In response to the positive determination in Step S12, the cut-in of the other vehicle CB in front of the host vehicle is determined to correspond to the close-range cut-in and the process proceeds to Step S14. In Step S14, it is determined whether the cut-off state occurs based on the captured image of the other vehicle CB acquired from the camera 21. In response to the negative determination in Step S14, the process proceeds to Step S15. In Step S15, the first close-range control unit 14 performs the first close-range control.

In response to the positive determination in Step S14, the process proceeds to Step S16. In Step S16, the second close-range control unit 15 performs the second close-range control. In the present embodiment, in response to the positive determination in Step S14, the second close-range control unit 15 counts a cut-off continuation time Tp during which the cut-off determination unit 13 continues to determine that the cut-off state occurs. In Step S16, the second close-range control unit 15 variably sets the predetermined deceleration ADa based on the cut-off continuation time Tp.

In detail, in response to switching of the determination result of the cut-off determination unit 13 from the determination that the cut-off state does not occur to the determination that the cut-off state occurs, the second close-range control unit 15 starts counting the cut-off continuation time Tp. In response to the cut-off continuation time Tp being zero during the second close-range control, the second close-range control unit 15 sets the predetermined deceleration ADa to an initial value.

The second close-range control unit 15 increments the cut-off continuation time Tp during a period when it is determined that the cut-off state occurs by the cut-off determination unit 13. In response to the cut-off continuation time Tp exceeding a predetermined cut-off time Ta during the second close-range control, the second close-range control unit 15 changes the predetermined deceleration ADa toward an increase side from the initial value.

For example, the predetermined deceleration ADa for the second deceleration control may be set as follows. In a first example, in response to the cut-off continuation time Tp exceeding the predetermined cut-off time Ta, the second close-range control unit 15 increases the predetermined deceleration ADa in a stepwise manner. In a second example, the second close-range control unit 15 sequentially increases the predetermined deceleration ADa in accordance with an increase in an excess of the cut-off continuation time Tp relative to the predetermined cut-off time Ta.

In response to the negative determination in Step S14, for example, the determination result of the cut-off determination unit 13 being switched from the determination that the cut-off state occurs to the determination that the cut-off state does not occur, the second close-range control unit 15 resets the cut-off continuation time Tp. Moreover, in response to the negative determination in Step S11 or S12, the second close-range control unit 15 also resets the cut-off continuation time Tp.

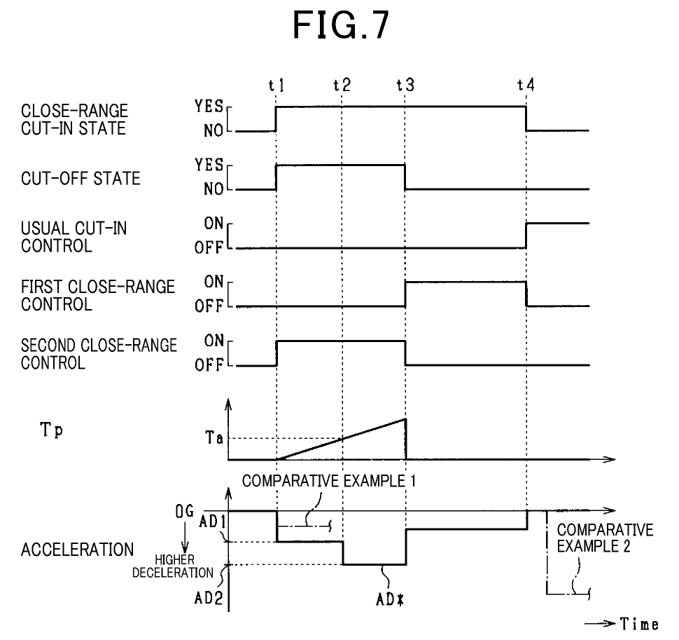

Next, description will be given on a control example of the deceleration control during the close-range cut-in of the other vehicle CB with reference to FIG. 7. It should be noted that in FIG. 7, the deceleration of the host vehicle CA is indicated as a negative value of the acceleration of the host vehicle.

The longitudinal distance D2 of the other vehicle CB cutting in front of the host vehicle is below the close-range determination value Dk at a time point t1. In this case, the close-range determination unit 12 performs switching from the determination that the close-range cut-in state does not occur to the determination that the close-range cut-in state occurs. The cut-off determination unit 13 determines that the rear end of the other vehicle CB is cut off in a captured image of the other vehicle CB acquired from the camera 21. In this case, the cut-off determination unit 13 performs switching from the determination that the cut-off state does not occur to the determination that the cut-off state occurs. The second close-range control unit 15 starts counting the cut-off continuation time Tp and sets the target deceleration AD* for the second close-range control to an initial value AD1 of the predetermined deceleration ADa.

At a time point t2, the cut-off continuation time Tp reaches the predetermined cut-off time Ta. In this case, the second close-range control unit 15 changes the target deceleration AD* for the second deceleration control to a value AD2, which is greater than the initial value AD1, of the predetermined deceleration ADa.

At a time point t3, the cut-off determination unit 13 determines that the rear end of the other vehicle CB appears in the captured image of the other vehicle CB. In this case, the cut-off determination unit 13 performs switching from the determination that the cut-off state occurs to the determination that the cut-off state does not occur. The second close-range control unit 15 resets the cut-off continuation time Tp and stops the second close-range control. The first close-range control unit 14 performs the first close-range control. This causes the target deceleration AD* to be set based on the longitudinal distance D2. Here, since the longitudinal distance D2 is increased by performing the second close-range control, the target deceleration AD* for the first close-range control is set to a value smaller than the values AD1 and AD2 set for the second close-range control.

At a time point t4, as a result of an increase in the inter-vehicle distance between the host vehicle CA and the other vehicle CB, the close-range determination unit 12 performs switching to the determination that the close-range cut-in state does not occur from the determination that the close-range cut-in state occurs. In this case, the first close-range control unit 14 stops the first close-range control. The deceleration control unit 11 performs the usual cut-in control. Specifically, during the usual cut-in control, the deceleration control unit 11 recognizes the other vehicle CB as a preceding vehicle and sets the target deceleration AD* so that the inter-vehicle distance to the preceding vehicle reaches the target inter-vehicle distance. Here, the first close-range control and the second close-range control are performed to ensure a sufficient inter-vehicle distance to the other vehicle CB before the usual cut-in control, so that the target deceleration AD* for the usual cut-in control is set to 0 G.

Dashed-dotted lines in FIG. 7 indicate transitions of deceleration in Comparative Example 1 and Comparative Example 2, in which it is not determined whether the cut-off state occurs. As Comparative Example 1, a configuration is assumed in which in response to the determination that the close-range cut-in state occurs, the target deceleration AD* is set based on the longitudinal distance D2 irrespective of whether the cut-off state occurs. For example, a value calculated based on the target object detection portion P in the side surface of the other vehicle CB detected using the radar device 22 is used as the longitudinal distance D2. In this case, the other vehicle CB may be unintentionally recognized as being present at a long distance, raising a concern that the deceleration of the host vehicle CA is unintentionally controlled to be low during the deceleration control and the deceleration of the host vehicle CA becomes insufficient.

As Comparative Example 2, a configuration is assumed in which during the close-range cut-in of the other vehicle CB, the deceleration control is not performed in a case where the rear end of the other vehicle CB is cut off in the image captured by the camera 21. In this case, there is a concern that a timing at which the deceleration control is started is delayed, making a collision with the other vehicle CB more likely to occur. Moreover, there is a concern that an extremely high deceleration is applied to the host vehicle CA during the following control performed when the other vehicle CB is recognized as a preceding vehicle.

In the present embodiment, in a case where the other vehicle CB traveling on the adjacent lane L2 is cutting in front of the host vehicle CA traveling on the host lane L1, it is determined whether the close-range cut-in state occurs. In a case where it is determined that the close-range cut-in state occurs, it is determined whether the cut-off state of the other vehicle CB occurs. In a case where it is determined that the cut-off state does not occur, the deceleration of the host vehicle CA for the deceleration control is controlled based on the longitudinal distance D2. In response to the determination that the cut-off state occurs, the deceleration of the host vehicle CA for the deceleration control is controlled to the predetermined deceleration ADa irrespective of the longitudinal distance D2. This makes it possible to decelerate the host vehicle CA while suppressing an adverse influence of the cut-off state on the deceleration control as compared with in Comparative Examples in which the execution mode of the deceleration control is not changed in accordance with whether the cut-off state occurs. Therefore, it is possible to perform an appropriate deceleration control even though the other vehicle CB is cutting in front of the host vehicle at a position close to the host vehicle CA.

For example, it is possible to suppress the adverse influence of the cut-off state, which is a concern regarding above-described Comparative Examples 1 and 2, on the deceleration control by performing the second close-range control. Specifically, as compared with in Comparative Example 1 in which the deceleration of the host vehicle CA is controlled based on the longitudinal distance D2 irrespective of whether the cut-off state occurs, it is possible to prevent the deceleration of the host vehicle CA from being unintentionally controlled to be low due to a decrease in the detection accuracy of the longitudinal distance D2 and, consequently, suppress occurrence of insufficient deceleration of the host vehicle CA. Moreover, as compared with in Comparative Example 2 in which the deceleration control is not performed in the cut-off state, it is possible to start the deceleration of the host vehicle CA at an early stage, thus properly reducing the probability of a collision with the other vehicle CB.

In a case where the cut-off continuation time Tp exceeds the predetermined cut-off time Ta, it can be considered that the predetermined deceleration ADa at the current moment requires more time than intended to eliminate the cut-off state. In this regard, the predetermined deceleration ADa is changed toward the increase side in response to the cut-off continuation time Tp exceeding the predetermined cut-off time Ta, which makes it possible to eliminate the cut-off state at an earlier timing. Therefore, it is possible to properly suppress occurrence of insufficient deceleration of the host vehicle CA in the cut-off state.

The second close-range control is performed during a period when it is determined that the cut-off state occurs by the cut-off determination unit 13. In response to the cut-off determination unit 13 performing switching from the determination that the cut-off state occurs to the determination that the cut-off state does not occur, the execution of the second close-range control is stopped. In a case where the close-range cut-in state continues when the cut-off state is eliminated, the first close-range control is performed. In a case where the cut-off state and the close-range cut-in state are eliminated, the usual cut-in control is performed. That is to say, in the cut-in scene of the other vehicle CB, deceleration by the second close-range control is performed in advance before the first close-range control or the usual cut-in control is performed. This makes it possible to suppress application of an extremely high deceleration to the host vehicle CA in a case where the first close-range control or the usual cut-in control is performed. Therefore, it is possible to suppress a feeling of strangeness caused to an occupant of the host vehicle CA when the first close-range control or the usual cut-in control is started.

Subsequently, description will be given on a control for notifying the occupant of the host vehicle CA of the approach of the other vehicle CB in the close-range cut-in scene.

The ECU 10 includes a warning control unit 16. The warning control unit 16 performs a warning control in response to the close-range determination unit 12 determining that the close-range cut-in state occurs. During the warning control, the warning control unit 16 issues a warning about the approach of the other vehicle CB in response to the longitudinal distance D2 becoming smaller than a warning determination value. Here, the warning determination value Dw is a value smaller than the close-range determination value Dk.

The control unit 16 includes, as a configuration for performing the warning control, a display control unit 17 and a notification control unit 18. In response to the close-range determination unit 12 determining that the close-range cut-in state occurs, the display control unit 17 causes the display 41 to display, as a warning for when the longitudinal distance D2 is smaller than the warning determination value Dw, the other vehicle CB on the adjacent lane L2. In response to the close-range determination unit 12 determining that the close-range cut-in state occurs, the notification control unit 18 causes the speaker 42 to output a warning sound as a warning for when the longitudinal distance D2 is smaller than the warning determination value Dw.

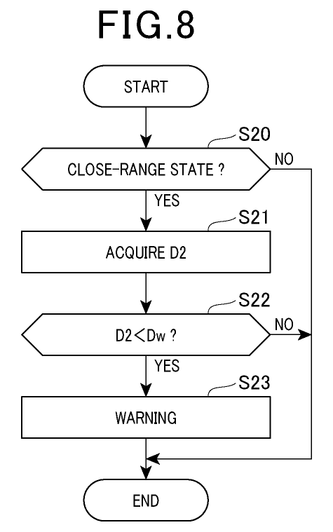

FIG. 8 illustrates a processing procedure of the warning control performed by the warning control unit 16. The control is repeatedly performed in a predetermined cycle and also in parallel with the control illustrated in above-mentioned FIG. 6.

In Step S20, it is determined whether the close-range determination unit 12 determines that the close-range cut-in state occurs. In response to the negative determination in Step S20, this control is terminated. In contrast, in response to the positive determination in Step S20, the process proceeds to Step S21.

In Step S21, the longitudinal distance D2 is acquired. In Step S22, it is determined whether the acquired longitudinal distance D2 is smaller than the warning determination value Dw. In response to the negative determination in Step S22, this control is terminated. In response to the positive determination in Step S22, the process proceeds to Step S23. In Step S23, a warning is issued. For example, the other vehicle CB cutting in front of the host vehicle is displayed on the display 41 and/or a warning sound is outputted from the speaker 42. This makes it possible to notify the occupant of the host vehicle CA of the approach of the other vehicle CB in the close-range cut-in scene of the other vehicle CB.

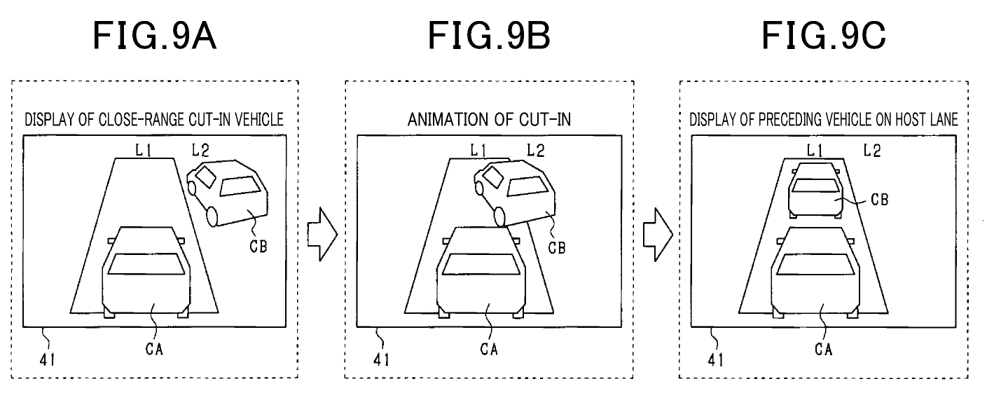

With use of FIG. 9, description will be given of a display mode of the display 41 in a case where the other vehicle CB is cutting in front of the host vehicle from the adjacent lane L2.

In FIG. 9, the other vehicle CB is traveling on the adjacent lane L2, which is on the right side of the host lane L1, at a front-right position relative to the host vehicle CA. In response to the determination that the longitudinal distance D2 is smaller than the warning determination value Dw in the close-range cut-in state, the display control unit 17 causes the display 41 to display the other vehicle CB traveling on the adjacent lane L2 as illustrated in FIG. 9A. In this case, for example, the display control unit 17 may cause at least one of the host lane L1 and the other vehicle CB to appear in a warning color such as red and/or cause the other vehicle CB to blink to emphasize the notification to the occupant of the host vehicle CA. The notification control unit 18 may cause the speaker 42 to output a warning sound to notify the occupant of the host vehicle CA.

In response to the other vehicle CB cutting in front of the host vehicle being recognized as a preceding vehicle for the following control, the display control unit 17 causes the display 41 to display the other vehicle CB as illustrated in FIGS. 9B and 9C. While the other vehicle CB is cutting in as illustrated in FIG. 9B, the display control unit 17 displays an animated image showing that the other vehicle CB is laterally moving toward the host lane L1. After the cut-in of the other vehicle CB is completed as illustrated in FIG. 9C, the display control unit 17 displays the other vehicle CB being at a position in front of the host vehicle on the host lane L1. The driver is thus notified that the other vehicle CB is selected as the preceding vehicle for the following control.

### Modification Examples of First Embodiment

Instead of variably setting the predetermined deceleration ADa in accordance with the cut-off continuation time Tp, the second close-range control unit 15 may change the predetermined deceleration ADa toward the increase side in a case where the traveling speed of the host vehicle CA is high while the other vehicle CB is cutting in front of the host vehicle as compared with in a case where the traveling speed is low. The second close-range control unit 15 may use the detection value from the speed sensor 23 as the traveling speed of the host vehicle CA.

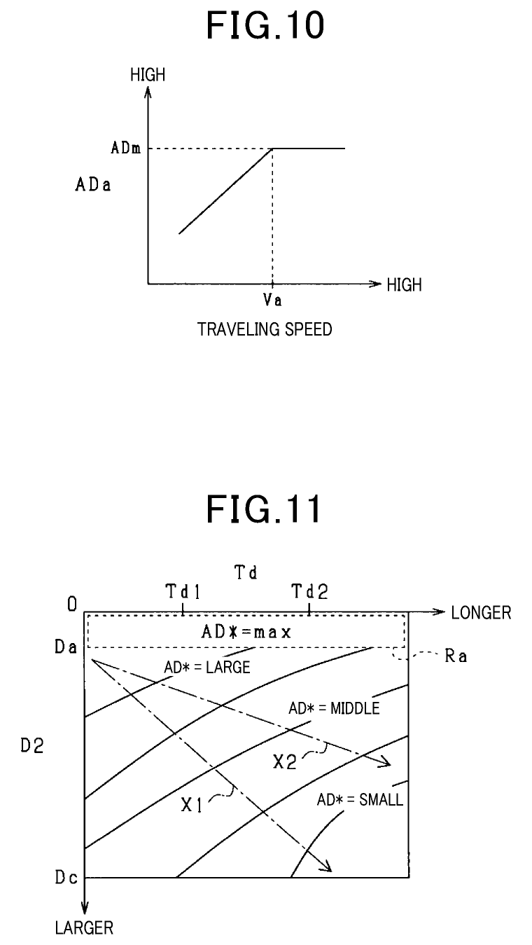

For example, the traveling speed of the host vehicle CA is higher than a predetermined speed Va, the second close-range control unit 15 sets the predetermined deceleration ADa to a maximum value ADm (for example, -0.1 G) as illustrated in FIG. 10. For a region in which the traveling speed of the host vehicle CA is lower than the predetermined speed Va, the second close-range control unit 15 sets the predetermined deceleration ADa to a value lower than the maximum ADm. During the second close-range control, this makes it possible to suppress occurrence of insufficient deceleration of the host vehicle CA in a case where the traveling speed of the host vehicle CA is high and suppress occurrence of a situation in which the host vehicle CA is decelerated at an extremely high deceleration in a case where the traveling speed of the host vehicle CA is low. Therefore, it is possible to suitably implement a configuration that controls the deceleration of the host vehicle CA to the predetermined deceleration ADa in the cut-off state.

For a region in which the traveling speed of the host vehicle CA is lower than the predetermined speed Va, the second close-range control unit 15 gradually increases the predetermined deceleration ADa within a range of ADa < Adm with an increase in the traveling speed of the host vehicle CA. This makes it possible to implement a suitable configuration for suppressing a situation in which the deceleration of the host vehicle CA becomes excessive or insufficient.

During the second close-range control, the second close-range control unit 15 may perform both of the process to change the predetermined deceleration ADa toward the increase side in response to the cut-off continuation time Tp exceeding the predetermined cut-off time Ta and the process to change the predetermined deceleration ADa toward the increase side in a case where the traveling speed of the host vehicle CA is high as compared with in a case where the traveling speed is low.

During the second close-range control, the second close-range control unit 15 may set the predetermined deceleration ADa to a fixed value instead of variably setting the predetermined deceleration ADa. In this case, the second close-range control unit 15 does not have to perform the process to count the cut-off continuation time Tp during the second close-range control. Moreover, the ECU 10 does not have to acquire the detection value from the speed sensor 23.

### Second Embodiment

The following describes a second embodiment, focusing on a difference from the first embodiment, with reference to the drawings. In the present embodiment, the processing contents of the first close-range control are changed.

Under circumstances in which the close-range cut-in state of the other vehicle CB occurs, it is not desirable that the host vehicle CA is unnecessarily decelerated and the close-range cut-in state is extremely prolonged due to insufficient deceleration of the host vehicle CA when the deceleration control of the host vehicle CA is performed.

Accordingly, during the first close-range control, the first close-range control unit 14 sets the target deceleration AD* based on, in addition to the longitudinal distance D2, a close-range continuation time Td during which the determination continues that the close-range cut-in state occurs. During the control in above-mentioned FIG. 6, the first close-range control unit 14 counts the close-range continuation time Td.

In the present embodiment, the first close-range control unit 14 counts, as the close-range continuation time Td, time during which the determination continues that the close-range cut-in state occurs. Specifically, in response to the positive determination in Step S12 in above-mentioned FIG. 6, the first close-range control unit 14 counts the close-range continuation time Td. In this case, the close-range continuation time Td is counted while the determination continues that the close-range cut-in state occurs, irrespective of the determination result of whether the cut-off state occurs in Step S14. In response to the negative determination of Step S11 or S12, the first close-range control unit 14 resets the close-range continuation time Td.

For example, the process to count the close-range continuation time Td is performed as follows. The first close-range control unit 14 starts counting the close-range continuation time Td in response to switching from the determination result that the close-range cut-in state does not occur to the determination result that the close-range cut-in state occurs. In a case where the close-range cut-in state has already been determined to occur, the first close-range control unit 14 increments the close-range continuation time Td.

It should be noted that the first close-range control unit 14 may count, as the close-range continuation time Td, time during which the determination continues that the close-range cut-in state occurs and the cut-off state does not occur. In this case, the process to count the close-range continuation time Td may be performed in response to the negative determination in Step S14 instead of being performed in response to the positive determination in Step S12.

In the present embodiment, in response to the determination that the close-range cut-in state occurs and the determination that the cut-off state does not occur, the target deceleration AD* for the first close-range control is set based on, in addition to the longitudinal distance D2, the close-range continuation time Td. This makes it possible to adjust the deceleration of the host vehicle CA for the first close-range control in accordance with a length of the close-range continuation time Td so as to suppress, for example, occurrence of a situation in which the host vehicle CA is unnecessarily decelerated during the close-range cut-in of the other vehicle CB. Therefore, it is possible to prevent the deceleration of the host vehicle CA for the first close-range control from becoming excessive or insufficient.

A detailed description will be given below on a method of setting the target deceleration AD* for the first close-range control. The first close-range control unit 14 sets the target deceleration AD* based on: the longitudinal distance D2 calculated based on the object detection information; the current close-range continuation time Td; and correspondence information in which the longitudinal distance D2, the close-range continuation time Td, and the target deceleration AD* are associated. In the present embodiment, the correspondence information is map information. It should be noted that the correspondence information may be mathematical information.

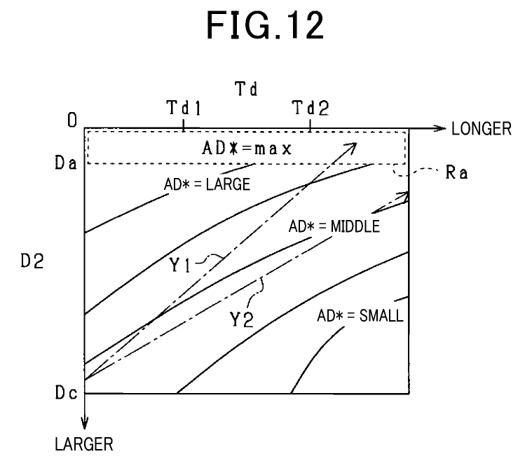

FIGS. 11 and 12 illustrate an example of the map information in which the longitudinal distance D2, the close-range continuation time Td, and the target deceleration AD* are associated. In the present embodiment, it is assumed that in the course of the other vehicle CB cutting in front of the host vehicle, the inter-vehicle distance (the longitudinal distance D2) between the host vehicle CA and the other vehicle CB increases over time. In this case, at the time when the close-range continuation time Td is short, the inter-vehicle distance to the other vehicle CB is short and the object recognition of the other vehicle CB may be unstable, so that it is considered that a collision with the other vehicle CB is highly likely to occur. In contrast, if the close-range continuation time Td is prolonged, the inter-vehicle distance increases as time elapses after the other vehicle CB starts cutting in, so that it is considered that an unnecessary deceleration is likely to occur during the first close-range control, although the likelihood of a collision with the other vehicle CB decreases. In view of the above, the map information illustrated in FIGS. 11 and 12, a basic tendency is defined so that the target deceleration AD* is set to a smaller value with an increase in the close-range continuation time Td. A detailed description will be given below on the map tendency in FIGS. 11 and 12.

In a case where the close-range continuation time Td is zero, the first close-range control unit 14 sets the initial value of the target deceleration AD*. In the present embodiment, the first close-range control unit 14 sets the initial value of the target deceleration AD* to a predetermined fixed value. The fixed value may be, for example, a maximum value of the target decelerations AD* settable for the first close-range control. The maximum value of the target decelerations AD* for the first close-range control may be, for example, the same value as the predetermined deceleration ADa, more specifically, -0.1 G.

In a case where Da < D2 < Dc after the initial value of the target deceleration AD* is set, the first close-range control unit 14 sets the target deceleration AD* based on the longitudinal distance D2 and the close-range continuation time Td. In the present embodiment, Dk described also in the first embodiment is referred to as "first close-range determination value Dk" and Da is referred to as "second close-range determination value Da." The second close-range determination value Da is smaller than the first close-range determination value Dk.

In detail, in a case where Da < D2 < Dc, the first close-range control unit 14 sets the target deceleration AD* to a smaller value with an increase in the close-range continuation time Td as long as the longitudinal distance D2 is the same or increases during the counting of the close-range continuation time Td. For example, in a case where positions on the longitudinal distance D2 and the close-range continuation time Td change as indicated by dashed-dotted lines X1 and X2 in FIG. 11, the target deceleration AD* set for a second continuation time Td2 is lower than the target deceleration AD* set for a first continuation time Td1. Here, the second continuation time Td2 is the close-range continuation time Td longer than the first continuation time Td1.

In a case where the longitudinal distance D2 increases during the counting of the close-range continuation time Td, the first close-range control unit 14 sets the lower target deceleration AD* with an increase in the degree of increase in the longitudinal distance D2. For example, in a distancing scene X1 in which the degree of increase in the longitudinal distance D2 relative to the close-range continuation time Td is large, the target deceleration AD* for the same close-range continuation time Td (for example, the first continuation time Td1) is set to a smaller value than in a distancing scene X2 in which the degree of increase in the longitudinal distance D2 relative to the close-range continuation time Td is small. During the close-range cut-in, this makes it possible to promptly reduce the deceleration of the host vehicle CA in a case where the degree of increase in the longitudinal distance D2 is large as compared with in a case where the degree of increase in the longitudinal distance D2 is small. Therefore, during the deceleration control in the distancing scene, it is possible to achieve a suitable control for suppressing an unnecessary deceleration of the host vehicle CA.

In the course of the other vehicle CB cutting in front of the host vehicle, the inter-vehicle distance between the host vehicle CA and the other vehicle CB does not always increase and sometimes decreases. In this case, it is considered that increasing the deceleration of the host vehicle CA is desirable for reducing the likelihood that the host vehicle CA collides with the other vehicle CB. In view of the above, as illustrated in FIG. 12, in a case where the other vehicle CB cutting in front of the host vehicle is close to the host vehicle CA, the tendency of the map information is defined so that the target deceleration AD* is set to a larger value with an increase in the close-range continuation time Td.

In detail, in a case where Da < D2 < Dc, the first close-range control unit 14 sets the target deceleration AD* to a larger value with an increase in the close-range continuation time Td as long as the longitudinal distance D2 decreases during the counting of the close-range continuation time Td. For example, in a case where the positions on the longitudinal distance D2 and the close-range continuation time Td change as indicated by dashed-dotted lines Y1 and Y2 in FIG. 12, the target deceleration AD* set for the second continuation time Td2 is higher than the target deceleration AD* set for the first continuation time Td1.

In a case where the longitudinal distance D2 decreases during the counting of the close-range continuation time Td, the first close-range control unit 14 sets the higher target deceleration AD* with an increase in the degree of decrease in the longitudinal distance D2. For example, in an approaching scene Y1 in which the degree of decrease in the longitudinal distance D2 relative to the close-range continuation time Td is large, the target deceleration AD* for the same close-range continuation time Td is set to a larger value as compared with in an approaching scene Y2 in which the degree of decrease in the longitudinal distance D2 relative to the close-range continuation time Td is small. During the close-range cut-in, this makes it possible to apply a higher deceleration to the host vehicle CA in a case where the degree of decrease in the longitudinal distance D2 is large as compared with in a case where the degree of decrease in the longitudinal distance D2 is small. Therefore, it is possible to achieve a suitable control for reducing the likelihood of a collision with the other vehicle CB during the deceleration control in the approaching scene.

In a case where the longitudinal distance D2 is within a range of 0 ≤ D2 ≤ Da, the first close-range control unit 14 sets the target deceleration AD* to the maximum value of the target decelerations AD* settable for the first close-range control irrespective of the close-range continuation time Td. This makes it possible to apply a possible highest deceleration to the host vehicle CA under a situation in which the other vehicle CB approaches the host vehicle CA at a very close range. Therefore, it is possible to achieve a suitable deceleration control for reducing the likelihood of a collision with the other vehicle CB in the close-range cut-in state.

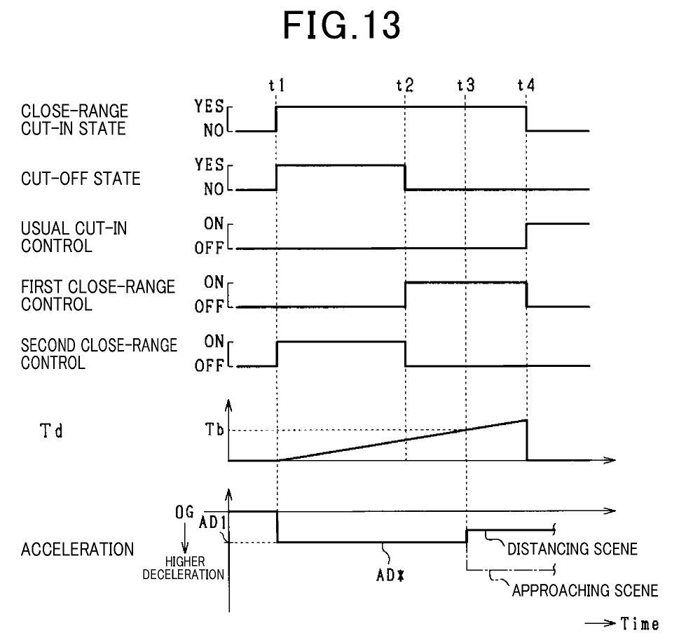

FIG. 13 illustrates a control example of the deceleration control during the close-range cut-in of the other vehicle CB. At the time point t1, the first close-range control unit 14 starts counting the close-range continuation time Td. The second close-range control unit 15 sets the target deceleration AD* for the second close-range control to the initial value AD1 of the predetermined deceleration ADa as in above-mentioned FIG. 7. FIG. 13 illustrates an example in which the predetermined deceleration ADa is fixed at the initial value AD1 during the second close-range control irrespective of the cut-off continuation time Tp. In this case, the second close-range control unit 15 does not have to perform a process to count the cut-off continuation time Tp.

At the time point t2, the cut-off determination unit 13 determines that the rear end of the other vehicle CB appears in the captured image of the other vehicle CB and, accordingly, performs switching from the determination that the cut-off state occurs to the determination that the cut-off state does not occur. The close-range determination unit 12 continues to determine that the close-range cut-in state occurs. In this case, the second close-range control unit 15 stops the second close-range control. The first close-range control unit 14 starts counting the close-range continuation time Td and also performs the first close-range control. Here, the target deceleration AD* for the first close-range control is set to the same value AD1 as that at or before the time point t2.

At the time point t3, the close-range continuation time Td reaches a predetermined close-range time Tb. In this case, the first close-range control unit 14 changes the target deceleration AD* for the first close-range control.

For example, the first close-range control unit 14 sets the target deceleration AD* to a value smaller than the initial value AD1 as long as the close-range continuation time Td reaches the predetermined close-range time Tb. This makes it possible to apply a deceleration lower than the initial value AD1 to the host vehicle CA and also ensure the inter-vehicle distance to the other vehicle CB in the distancing scene. Therefore, it is possible to suppress a feeling of strangeness caused to the occupant of the host vehicle CA and suppress an unnecessary deceleration during the deceleration control.

Moreover, for example, the first close-range control unit 14 sets the target deceleration AD* to a value larger than the initial value AD1 as long as the close-range continuation time Td reaches the predetermined close-range time Tb. This makes it possible to suppress the prolongation of the close-range cut-in state in the approaching scene. Therefore, it is possible to properly reduce the likelihood of a collision with the other vehicle CB during the close-range cut-in of the other vehicle CB.

In the present embodiment, the first close-range control unit 14 changes the target deceleration AD* for the first close-range control based on a change in the longitudinal distance D2 relative to the close-range continuation time Td. This makes it possible to adjust the deceleration of the host vehicle CA in accordance with whether the close-range cut-in scene is the approaching scene in which the other vehicle CB approaches the host vehicle CA or the distancing scene in which the other vehicle CB moves away from the host vehicle CA. Therefore, it is possible to properly prevent the deceleration of the host vehicle CA for the first close-range control from becoming excessive or insufficient.

Specifically, the first close-range control unit 14 sets the target deceleration AD* to a value smaller than the initial value AD1 as long as the close-range continuation time Td reaches the predetermined close-range time Tb and the longitudinal distance D2 is increasing during a period from when the close-range continuation time Td is zero until it reaches the predetermined close-range time Tb. Thus, after it is determined that the host vehicle CA moves away from the other vehicle CB in the close-range cut-in state and is unlikely to collide with the other vehicle CB, the deceleration of the host vehicle CA for the first close-range control is reduced. Therefore, it is possible to suitably achieve a control to suppress an unnecessary deceleration during the first close-range control.

The first close-range control unit 14 sets the target deceleration AD* to a value larger than the initial value AD1 as long as the close-range continuation time Td reaches the predetermined close-range time Tb and the longitudinal distance D2 decreases during a period from when the close-range continuation time Td is zero until it reaches the predetermined close-range time Tb. Thus, after it is determined that the other vehicle CB approaches the host vehicle CA in the close-range cut-in state and is highly likely to collide with the other vehicle CB, the deceleration of the host vehicle CA for the first close-range control is increased. Therefore, it is possible to suitably achieve a control to suppress a collision with the other vehicle CB during the first close-range control.

It should be noted that the first close-range control according to the present embodiment is not limited to adjusting the target deceleration AD* in a stepwise manner only once during a period when it is determined that the close-range cut-in state occurs and the cut-off state does not occur as illustrated in FIG. 13. The target deceleration AD* for the first close-range control may be adjusted at the following timing.

(X) In a first example, close-range times, which define timings to adjust the target deceleration AD* with respect to the close-range continuation time Td, may be defined in a plurality of stages and the target deceleration AD* may be adjusted when the close-range continuation time Td reaches each of the close-range times. In this case, during a period when it is determined that the close-range cut-in state occurs and the cut-off state does not occur, the first close-range control unit 14 may adjust the target deceleration AD* in a stepwise manner in multiple stages based on the current longitudinal distance D2, the current close-range continuation time Td, and the map information illustrated in above-mentioned FIGS. 11 and 12.

(Y) In a second example, the target deceleration AD* may be adjusted every increment of the close-range continuation time Td. In this case, during a period when it is determined that the close-range cut-in state occurs and the cut-off state does not occur, the first close-range control unit 14 may sequentially adjust the target deceleration AD* based on the current longitudinal distance D2, the incremented close-range continuation time Td, and the map information illustrated in above-mentioned FIGS. 11 and 12.

### Other Embodiments

The above-described embodiments may be modified, for example, as follows.
In the first close-range control according to the second embodiment, the map information in which the longitudinal distance D2, the close-range continuation time Td, and the target deceleration AD* are associated is not limited to map information having a tendency illustrated in above-mentioned FIGS. 11 and 12. For example, an unintentional prolongation of the close-range cut-in state, which leads to a prolongation of a state in which the detection accuracy of the other vehicle CB is low, is undesirable during the cut-in of the other vehicle CB. In view of the above, the tendency of the map information may be defined so that the target deceleration AD* is set to a larger value with an increase in the close-range continuation time Td. In this case, the first close-range control unit 14 may set the target deceleration AD* to a larger value with an increase in the close-range continuation time Td even though Da < D2 < Dc and the longitudinal distance D2 is constant or increases during the counting of the close-range continuation time Td. According to the present embodiment, it is possible to adjust the deceleration of the host vehicle CA for the first close-range control in accordance with the length of the close-range continuation time Td so as to suppress occurrence of insufficient deceleration of the host vehicle CA during the close-range cut-in of the other vehicle CB.
In the first close-range control according to the second embodiment, the target deceleration AD* set in a case where the longitudinal distance D2 is within a range of 0 ≤ D2 ≤ Da may be set to, in place of the maximum value of the target decelerations AD* settable for the first close-range control, a value smaller than the maximum value.
In the first close-range control according to the second embodiment, the first close-range control unit 14 may variably set the initial value of the target deceleration AD* based on the longitudinal distance D2 instead of setting the initial value to a fixed value.
Specifically, in a case where 0 ≤ D2 ≤ Da, the first close-range control unit 14 sets the initial value of the target deceleration AD* to the maximum value of the target deceleration AD* for the first close-range control. In a case where Da < D2 < D, the first close-range control unit 14 sets the initial value of the target deceleration AD* to a smaller value with an increase in the longitudinal distance D2. For example, with the assumption that the maximum value of the target deceleration AD* for the first close-range control is -0.1 G, the initial value of the target deceleration AD* is set within a range of -0.1 G < AD < 0 G in a case where Da < D2 < Dc.
In the above-described embodiments, description is given on the configuration in which it is determined whether the other vehicle CB is cutting in front of the host vehicle CA based on the lateral distance D1 from the host vehicle CA to the other vehicle CB, but it may be modified. For example, it may be determined whether the other vehicle CB is cutting in front of the host vehicle CA based on a lateral speed of the other vehicle CB in place of the lateral distance D1.
The control device and its method described in the present disclosure may be implemented by a dedicated computer including a memory and a processor programmed to execute one or a plurality of functions embodied by a computer program. Alternatively, the control device and its method described in the present disclosure may be implemented by a dedicated computer including a processor including one or more dedicated hardware logic circuits. Furthermore, the control device and its method described in the present disclosure may be implemented by one or more dedicated computers including a combination of a memory and a processor programmed to execute one or a plurality of functions and a processor including one or more hardware logic circuits. Additionally, the computer program may be stored in a computer-readable non-transitory tangible storage medium as instructions to be executed by a computer.

In the following, technical ideas extracted from the above-described embodiments will be described.

### Configuration 1

A vehicle control device (10) applicable to a vehicle, the vehicle including, as a detection device that detects an object around a host vehicle, an image sensor (21) configured to capture an image of surroundings of the host vehicle to acquire a captured image,
the vehicle control device performing a deceleration control to decelerate the host vehicle based on detection information regarding another vehicle provided by the detection device in response to the other vehicle traveling on an adjacent lane cutting in front of a host vehicle traveling on a host lane, the adjacent lane being adjacent to the host lane and being same in vehicle traveling direction as the host lane,
the vehicle control device comprising:
at least one of (i) a circuit and (ii) a processor with a memory storing computer program code executable by the processor, the at least one of the circuit and the processor configured to cause the vehicle control device to:
determine whether a close-range state occurs in which a separation distance to the other vehicle cutting in front of the host vehicle is smaller than a predetermined close-range determination value;
determine, in response to determining that the close-range state occurs, whether a cut-off state occurs in which the other vehicle is detected in the captured image and a rear end of the other vehicle is cut off in the captured image;
control, in response to determining that the close-range state occurs and determining that the cut-off state does not occur, a deceleration of the host vehicle for the deceleration control based on the separation distance; and
control, in response to determining that the cut-off state occurs, the deceleration of the host vehicle for the deceleration control to a predetermined deceleration irrespective of the separation distance.

### Configuration 2

The vehicle control device according to Configuration 1, in which the at least one of the circuit and the processor is further configured to cause the vehicle control device to: in response to a cut-off continuation time during which a determination continues that the cut-off state occurs exceeding a predetermined cut-off time, change the predetermined deceleration toward an increase side.

### Configuration 3

The vehicle control device according to Configuration 1 or 2, in which the at least one of the circuit and the processor is further configured to cause the vehicle control device to: in a case where a traveling speed of the host vehicle is high when the other vehicle cuts in front of the host vehicle, change the predetermined deceleration toward an increase side as compared with in a case where the traveling speed of the host vehicle is low.

### Configuration 4

The vehicle control device according to any one of Configurations 1 to 3, in which the at least one of the circuit and the processor is further configured to cause the vehicle control device to: in response to determining that the close-range state occurs and determining that the cut-off state does not occur, control the deceleration of the host vehicle for the deceleration control based on, in addition to the separation distance, a close-range continuation time during which a determination continues that the close-range state occurs.

### Configuration 5

The vehicle control device according to Configuration 4, in which the at least one of the circuit and the processor is further configured to cause the vehicle control device to: during a period when the close-range state occurs and the cut-off state does not occur, change the deceleration of the host vehicle for the deceleration control based on a change in the separation distance relative to the close-range continuation time.

### Configuration 6

The vehicle control device according to Configuration 4 or 5, in which the at least one of the circuit and the processor is further configured to cause the vehicle control device to: during a period when the close-range state occurs and the cut-off state does not occur, change the deceleration of the host vehicle for the deceleration control toward a decrease side as long as the close-range continuation time exceeds a predetermined close-range time.

### Configuration 7

The vehicle control device according to Configuration 4 or 5, in which the at least one of the circuit and the processor is further configured to cause the vehicle control device to: during a period when the close-range state occurs and the cut-off state does not occur, change the deceleration of the host vehicle for the deceleration control toward a decrease side as long as the close-range continuation time exceeds a predetermined close-range time and the separation distance is increasing during a period until the close-range continuation time exceeds the predetermined close-range time.

### Configuration 8

The vehicle control device according to any one of Configurations 4 to 7, in which the at least one of the circuit and the processor is further configured to cause the vehicle control device to: during a period when the close-range state occurs and the cut-off state does not occur, change the deceleration of the host vehicle for the deceleration control toward an increase side as long as the close-range continuation time exceeds a predetermined close-range time.

### Configuration 9

The vehicle control device according to any one of Configurations 4 to 7, in which the at least one of the circuit and the processor is further configured to cause the vehicle control device to: during a period when the close-range state occurs and the cut-off state does not occur, change the deceleration of the host vehicle for the deceleration control toward an increase side as long as the close-range continuation time exceeds a predetermined close-range time and the separation distance is decreasing during a period until the close-range continuation time exceeds the predetermined close-range time.

### Configuration 10

The vehicle control device according to any one of Configurations 1 to 9, in which
the vehicle further includes a warning device (40) configured to issue a warning to an occupant of the host vehicle,
a value smaller than the close-range determination value is defined as a warning determination value, and
the at least one of the circuit and the processor is further configured to cause the vehicle control device to control, in response to determining that the close-range state occurs, the warning device to issue the warning about approach of the other vehicle when the separation distance is smaller than the warning determination value.

### Configuration 11

The vehicle control device according to Configuration 10, in which
the warning device includes a display unit (41) visible to the occupant, and
the at least one of the circuit and the processor is further configured to cause the vehicle control device to cause, in response to determining that the close-range state occurs, the display unit to display the other vehicle on the adjacent lane as the warning when the separation distance is smaller than the warning determination value.

What is claimed is:

1. A vehicle control device applicable to a vehicle, the vehicle including, as a detection device that detects an object around a host vehicle, an image sensor configured to capture an image of surroundings of the host vehicle to acquire a captured image,
the vehicle control device performing a deceleration control to decelerate the host vehicle based on detection information regarding another vehicle provided by the detection device in response to the other vehicle traveling on an adjacent lane cutting in front of a host vehicle traveling on a host lane, the adjacent lane being adjacent to the host lane and being same in vehicle traveling direction as the host lane,
the vehicle control device comprising:
at least one of (i) a circuit and (ii) a processor with a memory storing computer program code executable by the processor, the at least one of the circuit and the processor configured to cause the vehicle control device to:
determine whether a close-range state occurs in which a separation distance to the other vehicle cutting in front of the host vehicle is smaller than a predetermined close-range determination value;
determine, in response to determining that the close-range state occurs, whether a cut-off state occurs in which the other vehicle is detected in the captured image and a rear end of the other vehicle is cut off in the captured image;
control, in response to determining that the close-range state occurs and determining that the cut-off state does not occur, a deceleration of the host vehicle for the deceleration control based on the separation distance; and
control, in response to determining that the cut-off state occurs, the deceleration of the host vehicle for the deceleration control to a predetermined deceleration irrespective of the separation distance.

2. The vehicle control device according to claim 1, wherein
the at least one of the circuit and the processor is further configured to cause the vehicle control device to:
in response to a cut-off continuation time during which a determination continues that the cut-off state occurs exceeding a predetermined cut-off time, change the predetermined deceleration toward an increase side.

3. The vehicle control device according to claim 1, wherein
the at least one of the circuit and the processor is further configured to cause the vehicle control device to:
in a case where a traveling speed of the host vehicle is high when the other vehicle cuts in front of the host vehicle, change the predetermined deceleration toward an increase side as compared with in a case where the traveling speed of the host vehicle is low.

4. The vehicle control device according to claim 1, wherein
the at least one of the circuit and the processor is further configured to cause the vehicle control device to:
in response to determining that the close-range state occurs and determining that the cut-off state does not occur, control the deceleration of the host vehicle for the deceleration control based on, in addition to the separation distance, a close-range continuation time during which a determination continues that the close-range state occurs.

5. The vehicle control device according to claim 4, wherein
the at least one of the circuit and the processor is further configured to cause the vehicle control device to:
during a period when the close-range state occurs and the cut-off state does not occur, change the deceleration of the host vehicle for the deceleration control based on a change in the separation distance relative to the close-range continuation time.

6. The vehicle control device according to claim 4, wherein
the at least one of the circuit and the processor is further configured to cause the vehicle control device to:
during a period when the close-range state occurs and the cut-off state does not occur, change the deceleration of the host vehicle for the deceleration control toward a decrease side as long as the close-range continuation time exceeds a predetermined close-range time.

7. The vehicle control device according to claim 4, wherein
the at least one of the circuit and the processor is further configured to cause the vehicle control device to:
during a period when the close-range state occurs and the cut-off state does not occur, change the deceleration of the host vehicle for the deceleration control toward a decrease side as long as the close-range continuation time exceeds a predetermined close-range time and the separation distance is increasing during a period until the close-range continuation time exceeds the predetermined close-range time.

8. The vehicle control device according to claim 4, wherein
the at least one of the circuit and the processor is further configured to cause the vehicle control device to:
during a period when the close-range state occurs and the cut-off state does not occur, change the deceleration of the host vehicle for the deceleration control toward an increase side as long as the close-range continuation time exceeds a predetermined close-range time.

9. The vehicle control device according to claim 4, wherein
the at least one of the circuit and the processor is further configured to cause the vehicle control device to:
during a period when the close-range state occurs and the cut-off state does not occur, change the deceleration of the host vehicle for the deceleration control toward an increase side as long as the close-range continuation time exceeds a predetermined close-range time and the separation distance is decreasing during a period until the close-range continuation time exceeds the predetermined close-range time.

10. The vehicle control device according to claim 1, wherein
the vehicle further includes a warning device configured to issue a warning to an occupant of the host vehicle,
a value smaller than the close-range determination value is defined as a warning determination value, and
the at least one of the circuit and the processor is further configured to cause the vehicle control device to control, in response to determining that the close-range state occurs, the warning device to issue the warning about approach of the other vehicle when the separation distance is smaller than the warning determination value.

11. The vehicle control device according to claim 10, wherein
the warning device includes a display unit visible to the occupant, and
the at least one of the circuit and the processor is further configured to cause the vehicle control device to cause, in response to determining that the close-range state occurs, the display unit to display the other vehicle on the adjacent lane as the warning when the separation distance is smaller than the warning determination value.

12. A vehicle control method for a vehicle, the vehicle including, as a detection device that detects an object around a host vehicle, an image sensor configured to capture an image of surroundings of the host vehicle to acquire a captured image,
the vehicle control method performing a deceleration control to decelerate the host vehicle based on detection information regarding another vehicle provided by the detection device in response to the other vehicle traveling on an adjacent lane cutting in front of a host vehicle traveling on a host lane, the adjacent lane being adjacent to the host lane and being same in vehicle traveling direction as the host lane, wherein
the vehicle control method comprising:
determining whether a close-range state occurs in which a separation distance to the other vehicle cutting in front of the host vehicle is smaller than a predetermined close-range determination value;
determining, in response to determining that the close-range state occurs, whether a cut-off state occurs in which the other vehicle is detected in the captured image and a rear end of the other vehicle is cut off in the captured image;
controlling, in response to determining that the close-range state occurs and determining that the cut-off state does not occur, a deceleration of the host vehicle for the deceleration control based on the separation distance; and
controlling, in response to determining that the cut-off state occurs, the deceleration of the host vehicle for the deceleration control to a predetermined deceleration irrespective of the separation distance.

13. A non-transitory computer-readable storage medium storing a program, the program being applicable to a vehicle, the vehicle including, as a detection device that detects an object around a host vehicle, an image sensor configured to capture an image of surroundings of the host vehicle to acquire a captured image,
the program performing a deceleration control to decelerate the host vehicle based on detection information regarding another vehicle provided by the detection device in response to the other vehicle traveling on an adjacent lane cutting in front of a host vehicle traveling on a host lane, the adjacent lane being adjacent to the host lane and being same in vehicle traveling direction as the host lane, wherein
the program causing a computer to:
determine whether a close-range state occurs in which a separation distance to the other vehicle cutting in front of the host vehicle is smaller than a predetermined close-range determination value;
determine, in response to determining that the close-range state occurs, whether a cut-off state occurs in which the other vehicle is detected in the captured image and a rear end of the other vehicle is cut off in the captured image;
control, in response to determining that the close-range state occurs and determining that the cut-off state does not occur, a deceleration of the host vehicle for the deceleration control based on the separation distance; and
control, in response to determining that the cut-off state occurs, the deceleration of the host vehicle for the deceleration control to a predetermined deceleration irrespective of the separation distance.
